(19) United States
(12) Patent Application Publication
(10) Pub. No.: US 2023/0325082 A1
(43) Pub. Date: Oct. 12, 2023

(54) METHOD FOR SETTING UP AND EXPANDING STORAGE CAPACITY OF CLOUD WITHOUT DISRUPTION OF CLOUD SERVICES AND ELECTRONIC DEVICE EMPLOYING METHOD

(71) Applicant: Fulian Precision Electronics (Tianjin) Co., LTD., Tianjin (CN)

(72) Inventors: CHUN-HSIEN LIN, New Taipei (TW); CHENG-CHEN CHANG CHIAN, New Taipei (TW)

(21) Appl. No.: 17/728,064

(22) Filed: Apr. 25, 2022

(30) Foreign Application Priority Data
Mar. 22, 2022 (CN) 202210289246.X

(51) Int. Cl. G06F 3/06

(52) U.S. Cl. CPC G06F 3/0608; G06F 3/0655; G06F 3/067

(57) ABSTRACT

A method for expanding in a balanced manner storage capacity in a cloud without disruption of services provided by the cloud to users includes setting a capacity expansion target of a storage pool of memory devices according to disk space occupation of service currently provided by the storage system when an additional storage node is added to the storage pool of the storage system, expanding the capacity of the storage pool according to the capacity expansion target and adjusting capacity expansion parameter of the storage pool in different periods of time. An electronic device and a non-volatile storage medium performing the above-described method are also disclosed.

### TECHNICAL FIELD

The present disclosure relates to relates to the field of cloud storage technology, and more particularly to storage capacity expansion method and electronic device.

### BACKGROUND

When the capacity of the cloud storage system is insufficient, storage nodes can be added to expand the capacity.

Newly added storage nodes will cause an imbalance of the original data distribution, and in order to continue to maintain the data balance, the cloud storage system will trigger an internal mechanism to recalculate the distribution location of the data and migrate data to the calculated locations. The migrating of data requires the use of the central processing unit, disk, network, and other resources in the node, these resources are also provided to the service which allows access to the cloud. Therefore, the expansion will affect the access service, which may cause data access freezes and delays. This will affect the user experience.

Therefore, improvement is desired.

### SUMMARY OF THE DISCLOSURE

The embodiment of the present disclosure aims to provide a storage capacity expansion method and device and electronic device to solve the above technical problems, so as to reduce the impact of the storage capacity expansion on data access services and make full use of the resources of the storage system.

The embodiment of the present disclosure provides a storage capacity expansion method, the storage capacity expansion method can be applied to a storage system, the method includes:
setting a capacity expansion target of a storage pool of memory devices according to disk space occupation of service currently provided by the storage system when a storage node is added to the storage pool of the storage system; and
expanding the capacity of the storage pool according to the capacity expansion target and adjusting capacity expansion parameter of the storage pool in different periods of time.

In some embodiments, wherein the expanding of the capacity of the storage pool according to the capacity expansion target, further includes:
modifying a weighting of each storage node in the storage pool, and migrating data to be migrated stored by an original storage node in the storage pool to a new storage node;
determining whether the storage pool reaches the capacity expansion target when data migration is completed; and
stopping the data migration when the storage pool reaches the capacity expansion target.

In some embodiments, the method further includes

modifying the weighting again and migrating the data again until the storage pool reaches the capacity expansion target if the storage pool does not reach the capacity expansion target.

In some embodiments, the capacity expansion target comprises a target weighting of each storage node in the storage pool, the target weighting represents total disk capacity to be achieved by the storage node after capacity expansion, and / or represents data migration amount of the storage node during capacity expansion.

In some embodiments, wherein the capacity expansion parameter includes speed of data migration, the adjusting of capacity expansion parameter of the storage pool in different periods of time further includes:
setting a peak period and an off peak period according to service busy state of the storage system;
limiting the speed of the data migration when the storage pool is in the peak period; and
accelerating the data migration speed when the storage pool is in the off peak.

In some embodiments, the service busy state of the storage system is obtained according to historical traffic of the storage pool and a number of reads and writes of the disk in a historical unit time.

In some embodiments, wherein the setting of a peak period and an off peak period according to service busy state of the storage system, further includes:
setting a busy service period as the peak period; and
setting a service idle period as the off peak period.

The embodiment of the present disclosure provides a computer storage medium, the computer storage medium stores a plurality of instructions, which are suitable for loading and executing the storage capacity expansion method by a processor.

The embodiment of the present disclosure provides an electronic device, the electronic device includes at least one processor and a computer storage medium for storing a plurality of instructions. The processor is used to run the instructions to execute the above storage capacity expansion method.

Compared with the prior art, the application has the following advantages:
1. The storage capacity expansion method of the present disclosure can provide an elastic strategy for expansion of storage. For different applications or services, the data migration amount during capacity expansion can be adjusted accordingly. In the process of the capacity expansion, the speed of the data migration can also be flexibly adjusted based on different periods of time, so that the storage system can achieve a good balance between the capacity expansion and the service provision and avoid an impact on the service due to the excessive amounts of migrated data or a migration speed which is too fast. Therefore, it can effectively improve the user experience.
2. The storage capacity expansion method of the present disclosure can evaluate the condition of the storage system to adjust the expansion target and expansion parameters. The capacity expansion can also be carried out when the service is busy, and can be accelerated when the service is idle, so that the storage capacity expansion method of the present disclosure can be applied to a variety of service scenarios of the storage system.
3. The storage capacity expansion method of the present disclosure can realize the data balance of the storage system, avoid the performance problems caused by an excessive load on the original storage node, and finally improve the reliability and availability of the data stored by the storage node.
4. The storage capacity expansion method of the present disclosure can adopt a slow migration strategy at the peak period and an active migration strategy at the off peak period, so as to make full use of the resources of the storage system and improve the efficiency of migration.

### BRIEF DESCRIPTION OF THE DRAWINGS

FIG. 1 is a flowchart of a storage capacity expansion method according to an embodiment of the present disclosure.

FIG. 2 is a schematic diagram of a Ceph distributed storage system according to another embodiment of the present disclosure.

FIG. 3 is a flowchart of the storage capacity expansion method according to another embodiment of the present disclosure.

FIG. 4 is a block diagram of a storage expansion device according to an embodiment of the present disclosure.

FIG. 5 is a schematic diagram of an electronic device according to an embodiment of the present disclosure.

### DETAILED DESCRIPTION

The technical solutions in the embodiments of the present disclosure will be described in conjunction with the accompanying drawings in the embodiments of the present disclosure. Obviously, the described embodiments are part of the embodiments of the present disclosure, not all of them. Based on the embodiments of the present disclosure, all other embodiments obtained by those of ordinary skill in the art without creative work shall fall within the protection scope of the present disclosure.

It should be noted that “at least one” in the embodiment of the present disclosure refers to one or more, and multiple refers to two or more. For example, the terms “first”, “second”, “third”, “fourth” in the description, claims and drawings of the application are used to distinguish similar objects, rather than to describe a specific order.

The embodiment of the present disclosure provides a storage capacity expansion method, the storage capacity expansion method can be applied to a storage system. When the capacity of the storage system is insufficient for users, the method of the present disclosure can make the storage system achieve a good balance between capacity expansion and service provision, and expand the capacity of the storage system without affecting the services provided by the storage system.

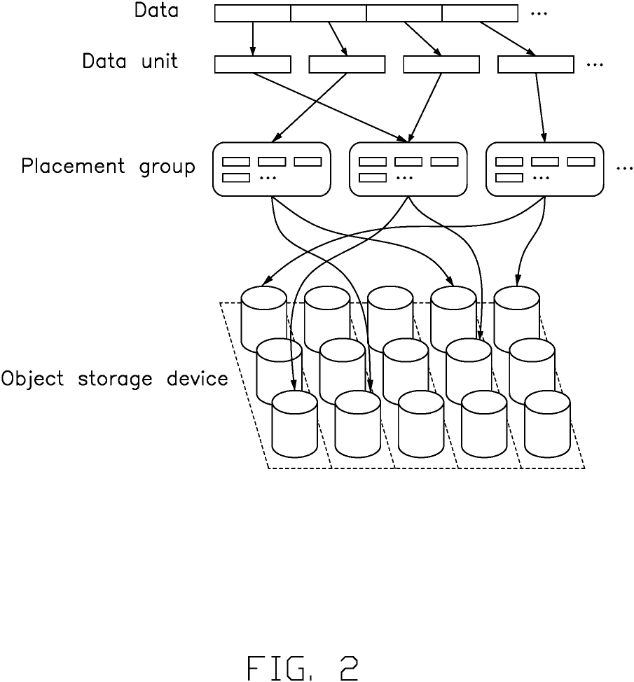

The storage system may be a cloud storage system. The cloud storage system can adopt distributed storage system, for example, a Ceph distributed storage system can be adopted. During data storage in Ceph distributed storage system, the data is first divided into multiple data units (objects), and each object is mapped to a placement group (PG) through hash algorithm. One placement group can include multiple objects, and can be used to manage objects. The placement group is then mapped to the object storage device (OSD) through the crush algorithm, as shown in FIG. 2. The object storage device is equivalent to storage node. The object storage device can use a disk directly. Several object storage devices can be combined into a storage pool of memory devices.

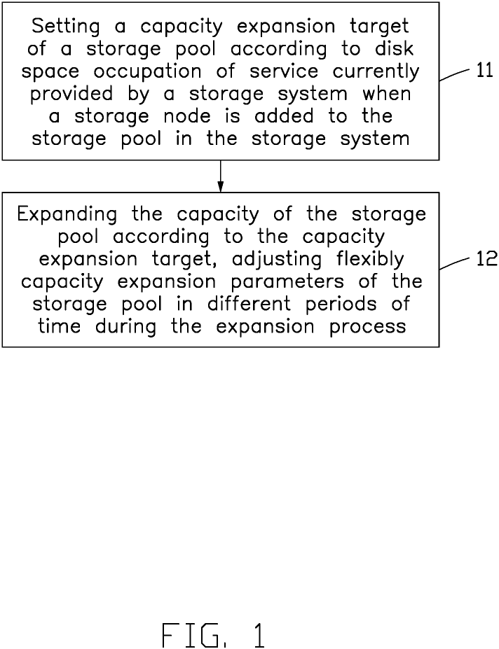

FIG. 1 is a flowchart depicting an embodiment of a storage capacity expansion method.

Each block shown in FIG. 1 represents one or more processes, methods, or subroutines, carried out in the example method. Furthermore, the illustrated order of blocks is illustrative only and the order of the blocks can change. Additional blocks can be added or fewer blocks may be utilized, without departing from the present disclosure. The example method can begin at block 11.

At block 11, setting a capacity expansion target of a storage pool according to disk space occupation of service currently provided by a storage system when a storage node is added to the storage pool in the storage system.

The capacity expansion target includes the target weighting of each storage node in the storage pool.

Each storage node includes multiple disks, and each disk has its corresponding weighting, the weighting depends on the disk capacity. The larger the disk capacity, the greater is the weighting. The weighting of a storage node is the sum of weightings of all disks in the storage node. It can be seen that the target weighting represents the total disk capacity to be achieved by the storage node after capacity expansion.

The larger the total disk capacity of the storage node, the greater is the amount of data migration of the storage node in the process of the capacity expansion. Therefore, the target weighting also represents the data migration amount of the storage node in the process of capacity expansion in order to achieve the total disk capacity.

As both service and capacity expansion require resources which are limited. When the storage system provides services and capacity expansion at the same time, the data migration amount will affect the services. The greater the data migration amount, the greater is the demand for resources, so the greater is the impact on services. For example, when the service occupies more disk space, less disk space can be used for capacity expansion. Therefore, excessive data migration amount may lead to resource conflict and affect the normal provision of the services. Therefore, when the disk space occupied by the service is large, a smaller capacity expansion target can be set to generate a smaller data migration amount, so as to avoid affecting the normal provision of the service. When the disk space occupied by the service is small, a large capacity expansion target can be set to generate a large data migration amount, so as to make rational use of the resources of the storage system.

In some embodiments, the capacity expansion target can be calculated based on deep learning technology.

For example, the deep learning model is used to automatically output the capacity expansion target of the storage pool. The deep learning model includes but is not limited to AlexNet, VggNet, GoogleNet, ResNet, DenseNet, not being specifically limited in the embodiment of the present disclosure.

In one embodiment, the storage capacity expansion method further includes:

Monitoring disk utilization.

When the disk utilization reaches an upper limit, this indicates that the disk capacity will be full, so a new storage node must be added to the storage pool.

The upper limit can be set according to the actual situation. For example, it can be set to any value in the range of 70% to 80% disk utilization.

At block 12, expanding the capacity of the storage pool according to the capacity expansion target, adjusting flexibly capacity expansion parameters of the storage pool in different periods of time during the expansion process.

When a storage node is added to any storage pool in the storage system, the storage pool will recalculate the data distribution location and migrate the data according to the distribution location. The affected range in the storage system can be limited to the storage pool where the new storage node is located, without affecting unrelated storage pools. Therefore, in the process of the capacity expansion, the storage capacity expansion method can only set the capacity expansion target and adjust the capacity expansion parameters for the storage pool which includes the new storage node.

In one embodiment, the expanding the capacity of the storage pool according to the capacity expansion target includes the following steps:

modifying the weighting of each storage node in the storage pool, and migrating the data to be migrated stored by the original storage node in the storage pool to the new storage node. When the storage system modifies the weighting, the internal mechanism of the storage system will be triggered and data migration will occur.

determining whether the storage pool reaches the capacity expansion target when data migration is completed.

stopping the data migration when the storage pool reaches the capacity expansion target.

modifying the weighting again and migrating the data again if the storage pool does not reach the capacity expansion target.

In one embodiment, when the data migration is completed, the storage capacity expansion method further includes the following steps:

deleting the data to be migrated in the original storage node to free up disk space.

It can be understood that through the above iterative migrations, each storage node in the storage pool can achieve the capacity expansion target. The data of the expanded storage pool is balanced, the data is evenly distributed, and there will be no situation where the load of the original storage node is too high and the available space is insufficient, while the available space presented by the new storage node is unused or is too much.

The capacity expansion parameters include the speed of the data migration.

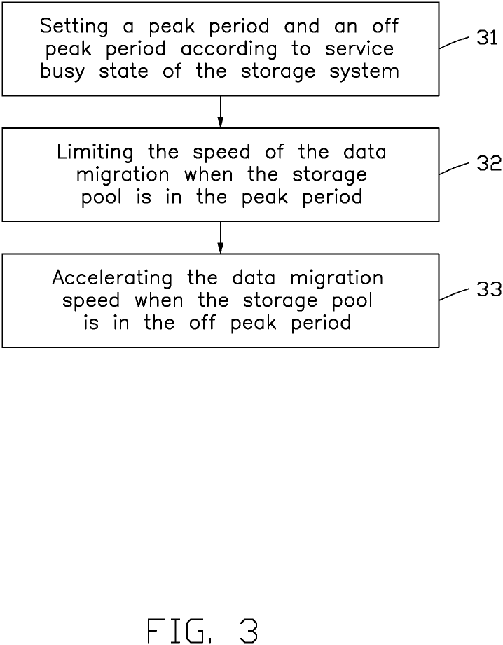

In one embodiment, as shown in FIG. 3, the flexible adjusting of the capacity expansion parameters of the storage pool in different periods of time includes the following steps:

At block 31, setting a peak period and an off peak period according to service busy state of the storage system.

Block 31 is as follows:
determining a state as being service busy of the storage system during capacity expansion according to the historical traffic of the storage pool and the number of disk reads and writes in the historical unit time;
setting the busy service period as the peak period and the service idle period as the off peak period during the capacity expansion.

The traffic represents disk throughput, and the amount of read and write data on the disk. The number of the disk reads and writes per unit time refers to input / output per second (IOPS). Both the traffic and the IOPS can be used as the loading of data to characterize the workload of the storage system. The larger the traffic and the IOPs, the more service requests that the storage system can handle, that is, which indicates that the system is busier. Therefore, the traffic threshold and IOPs threshold can be set according to the historical traffic and historical IOPS. In the process of the capacity expansion, it can be determined whether the storage system is busy according to the traffic threshold and IOPs threshold, and the peak period and the off peak period can then be determined.

At block 32, limiting the speed of the data migration when the storage pool is in the peak period.

At block 33, accelerating the data migration speed when the storage pool is in the off peak.

Both the service and the capacity expansion require resources which are limited. When the storage system provides the service and the capacity expansion at the same time, the speed of the data migration of the capacity expansion will affect the service. The higher the speed of the data migration, the faster and greater will be the demand for resources, so there will be a greater impact on the services. Therefore, in the peak period, due to the heavy workload of the storage system, in order to ensure the normal provision of the services, the proportion of resources used for the capacity expansion can be appropriately reduced. Therefore, the speed of the data migration can be reduced to an appropriate value or value range to reduce the impact on the services. In the off peak period, due to the lighter workload of the storage system, the proportion of resources used for the capacity expansion can be appropriately increased. Therefore, the speed of the data migration can be increased to an appropriate value or value range to make full use of the resources of the storage system.

The maximum speed that can be reached after acceleration and the maximum speed that can be reached after speed limit can be set accordingly according to the type of actual storage system and service, the present disclosure not being limited.

In some embodiments, the capacity expansion parameters can also be calculated based on the deep learning technology. For example, the historical load data of the storage pool (including the historical traffic and the historical IOPS) can be collected, and the historical load data taken as a training sample to train a deep learning model, and the deep learning model is used to automatically output the capacity expansion parameters corresponding to each period in the process of the capacity expansion. The embodiment of the present disclosure does not limit the type of the deep learning model.

The storage capacity expansion method of the present disclosure can provide elasticity in the capacity expansion strategy according to the situation of the storage system, the method can provide elastic capacity expansion objectives and elastic capacity expansion parameters, so that the storage system can achieve a good balance between capacity expansion and service provision, which reduces the impact of storage capacity expansion on services and makes full use of the resources of the storage system.

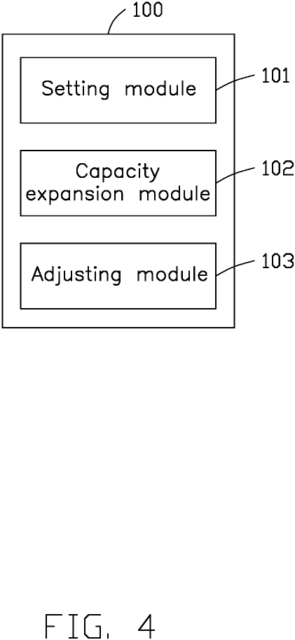

FIG. 4 illustrates a storage capacity expansion device 100 in accordance with an embodiment of the present disclosure.

The storage capacity expansion device 100 can be used to realize the above storage capacity expansion method.

In the embodiment, the storage capacity expansion device 100 may include a setting module 101, capacity expansion module 102, and an adjusting module 103.

The setting module 101 is used to set a capacity expansion target of a storage pool of memory devices according to disk space occupation of service currently provided by a storage system when an additional storage node is added to the storage pool in the storage system.

The capacity expansion module 102 is used to expand the capacity of the storage pool according to the capacity expansion target until the storage pool reaches the corresponding expansion target.

The adjusting module 103 is used for flexibility in adjusting the capacity expansion parameters of the storage pool in different periods of time during the expansion process.

In this embodiment, the capacity expansion module 102 includes a weight modifying module, a data migrating module, and a determining module.

The weight modifying module is used to modify the weighting of each storage node in the storage pool.

The data migrating module is used to migrate the data to be migrated stored by the original storage node in the storage pool to the new storage node when the weighting is modified.

The determining module is used to determine whether the storage pool has reached the capacity expansion target after the data migration is completed. If the storage pool has reached the capacity expansion target, the capacity expansion module 12 will stop the data migration of the data migration module. If storage pool does not reach the capacity expansion target, the capacity expansion module 102 can modify the weighting again through the weight modifying module.

In the embodiment, the adjusting module 103 includes a period setting module, a speed limiting module, and an acceleration module.

The period setting module is used to set the peak period and the off peak period according to the service busy state of the storage system.

The speed limiting module is used to limit the speed of the data migration when the storage pool is in the peak period.

The acceleration module is used to accelerate the data migration speed when the storage pool is in the off peak period.

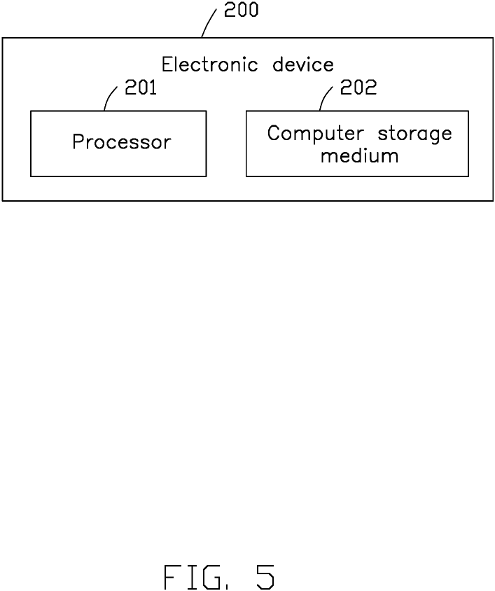

The present disclosure also provides a computer storage medium 202 (shown in FIG. 5). The computer storage medium 202 stores a plurality of instructions, which are suitable for loading and executing by a processor 201 (shown in FIG. 5) to realize the steps of the above storage capacity expansion method. The system and method specifically include:
setting a capacity expansion target of a storage pool according to disk space occupation of service currently provided by a storage system when an additional storage node is added to the storage pool in the storage system; and
expanding the capacity of the storage pool according to the capacity expansion target, flexibly adjusting capacity expansion parameters of the storage pool in different periods of time.

FIG. 5 illustrates an electronic device 200 in accordance with an embodiment of the present disclosure.

In the embodiment, the electronic device 200 may also include at least one processor 201 and a computer storage medium 202.

The computer storage medium 202 is used to store a plurality of instructions. The processor 201 may run the instructions to execute the above storage capacity expansion method.

The instructions in the above computer storage medium 202 can be realized in the form of software functional units and can be stored in a computer storage medium when sold or used as an independent product.

The computer storage medium 202 may be configured to store software programs and computer executable programs, such as program instructions corresponding to the storage capacity expansion method in the embodiment of the present disclosure or modules in the storage capacity expansion device 100. The processor 201 executes function applications and data processing by running software programs, instructions or modules stored in the computer storage medium 202, that is, the storage capacity expansion method in the above embodiment is realized. The processor 201 may execute the program code of program segment stored in the computer storage medium 202 to implement blocks 11-12 in method shown in FIG. 1 and blocks 31-33 in method shown in FIG. 3.

In some embodiments, the electronic device 200 may be a server, such as a cloud server.

In the embodiment of the present disclosure, the computer storage medium 202 includes nonvolatile computer-readable memory, such as disk, or other memory storage. It is understood that the computer storage medium 202 may also include other nonvolatile computer-readable memories, such as plug-in hard disk, smart media card (SMC), secure digital (SD) card, flash card, at least one flash memory device and / or other nonvolatile solid-state storage devices.

In the embodiment of the present disclosure, the processor 201 may be a central processing unit (CPU), other general-purpose processor, digital signal processor (DSP), application specific integrated circuit (ASIC), field programmable gate array (FPGA) or other programmable logic device, discrete gate or transistor logic device discrete hardware component. The processor 201 is the control center of the electronic device 200 and can connect other devices and / or systems / modules / units using various interfaces and lines to provide data storage and data access services to the applications of other devices and / or systems / modules / units.

Those of ordinary skill in the art should realize that the above embodiments are only used to illustrate the present disclosure, but not to limit the present disclosure. As long as they are within the essential spirit of the present disclosure, the above embodiments are appropriately made and changes fall within the scope of protection of the present disclosure.

What is claimed is:

1. A storage capacity expansion method applied to a storage system, comprising:
setting a capacity expansion target of a storage pool according to disk space occupation of service currently provided by the storage system when a storage node is added to the storage pool of the storage system;
expanding the capacity of the storage pool according to the capacity expansion target and adjusting capacity expansion parameter of the storage pool in different periods of time;
wherein the expanding the capacity of the storage pool according to the capacity expansion target, further comprises:
modifying weight of each storage node in the storage pool, and migrating data to be migrated stored by an original storage node in the storage pool to a new storage node; and
determining whether the storage pool reaches the capacity expansion target when data migration is completed and stopping the data migration when the storage pool reaches the capacity expansion target.

2. (canceled)

3. The storage capacity expansion method of claim 1, further comprising:
modifying the weight again and migrating the data again until the storage pool reaches the capacity expansion target when the storage pool does not reach the capacity expansion target.

4. The storage capacity expansion method of claim 1, wherein the capacity expansion target comprises a target weight of each storage node in the storage pool, the target weight represents total disk capacity to be achieved by the storage node after capacity expansion, and / or represents data migration amount of the storage node during capacity expansion.

5. The storage capacity expansion method of claim 1, wherein the capacity expansion parameter includes speed of data migration, the adjusting capacity expansion parameter of the storage pool in different periods of time further comprises:
setting a peak period and an off peak period according to service busy state of the storage system;
limiting the speed of the data migration when the storage pool is in the peak period; and
accelerating the data migration speed when the storage pool is in the off peak.

6. The storage capacity expansion method of claim 5, wherein the service busy state of the storage system is obtained according to historical traffic of the storage pool and a number of reads and writes of the disk in a historical unit time.

7. The storage capacity expansion method of claim 6, wherein the setting a peak period and an off peak period according to service busy state of the storage system, further comprises:
setting a busy service period as the peak period; and
setting a service idle period as the off peak period.

8. An electronic device comprising:
a computer storage medium and
at least one processor, wherein the computer storage medium stores one or more programs, when executed by the at least one processor, the one or more programs cause the at least one processor to:
set a capacity expansion target of a storage pool according to disk space occupation of service currently provided by the storage system when a storage node is added to the storage pool of the storage system;
expand the capacity of the storage pool according to the capacity expansion target and adjust capacity expansion parameter of the storage pool in different periods of time;
modify weight of each storage node in the storage pool, and migrating data to be migrated stored by an original storage node in the storage pool to a new storage node; and
determine whether the storage pool reaches the capacity expansion target when data migration is completed and stop the data migration when the storage pool reaches the capacity expansion target.

9. (canceled)

10. The electronic device according to claim 8, wherein the at least one processor is further caused to:
modify the weight again and migrating the data again until the storage pool reaches the capacity expansion target when the storage pool does not reach the capacity expansion target.

11. The electronic device according to claim 8, wherein the capacity expansion target comprises a target weight of each storage node in the storage pool, the target weight represents total disk capacity to be achieved by the storage node after capacity expansion, and / or represents data migration amount of the storage node during capacity expansion.

12. The electronic device according to claim 8, wherein the at least one processor is further caused to:
set a peak period and an off peak period according to service busy state of the storage system;
limit speed of the data migration when the storage pool is in the peak period; and
accelerate the data migration speed when the storage pool is in the off peak.

13. The electronic device according to claim 12, wherein the service busy state of the storage system is obtained according to historical traffic of the storage pool and a number of reads and writes of the disk in a historical unit time.

14. The electronic device according to claim 13, wherein the at least one processor is further caused to:
set a busy service period as the peak period; and
set a service idle period as the off peak period.

15. A non-transitory storage medium having stored thereon instructions that, when executed by a processor of a computer device installed in an electronic device, cause the processor to perform a storage capacity expansion method, wherein the storage capacity expansion method comprises:
setting a capacity expansion target of a storage pool according to disk space occupation of service currently provided by the storage system when a storage node is added to the storage pool of the storage system;
expanding the capacity of the storage pool according to the capacity expansion target and adjusting capacity expansion parameter of the storage pool in different periods of time;
wherein the expanding the capacity of the storage pool according to the capacity expansion target, further comprises:
modifying weight of each storage node in the storage pool, and migrating data to be migrated stored by an original storage node in the storage pool to a new storage node;
determining whether the storage pool reaches the capacity expansion target when data migration is completed and stopping the data migration when the storage pool reaches the capacity expansion target.

16. The non-transitory storage medium of claim 15, wherein the expanding the capacity of the storage pool according to the capacity expansion target, further comprises:
modifying the weight again and migrating the data again until the storage pool reaches the capacity expansion target when the storage pool does not reach the capacity expansion target.

17. The non-transitory storage medium of claim 15, wherein the capacity expansion target comprises a target weight of each storage node in the storage pool, the target weight represents total disk capacity to be achieved by the storage node after capacity expansion, and / or represents data migration amount of the storage node during capacity expansion.

18. The non-transitory storage medium of claim 15, wherein the capacity expansion parameter includes speed of data migration, the adjusting capacity expansion parameter of the storage pool in different periods of time further comprises:
setting a peak period and an off peak period according to service busy state of the storage system;
limiting the speed of the data migration when the storage pool is in the peak period; and
accelerating the data migration speed when the storage pool is in the off peak.

19. The non-transitory storage medium of claim 18, wherein the service busy state of the storage system is obtained according to historical traffic of the storage pool and a number of reads and writes of the disk in a historical unit time.

20. The non-transitory storage medium of claim 19, wherein the setting a peak period and an off peak period according to service busy state of the storage system, further comprises:
setting a busy service period as the peak period; and
setting a service idle period as the off peak period.
